(19) United States
(12) Patent Application Publication
(10) Pub. No.: US 2004/0030710 A1
(43) Pub. Date: Feb. 12, 2004

(54) Rules-based task browser for engineering systems

(76) Inventor: Thomas Shadle, Venetia, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/152,543

(22) Filed: May 21, 2002

Related U.S. Application Data
(60) Provisional application No. 60/292,392, filed on May 21, 2001.

(51) Int. Cl. G06F 17/00

(52) U.S. Cl. 707/102

(57) ABSTRACT

A rules-based task browser for engineering systems interprets a rule set to respond interactively to events in the application, and provides navigation to and information about tools and data in the application. Unlike traditional assistance mechanisms the present invention provides in-context interpreted content and does not provide an alternative interface. The present invention may also take input and drive the application. The present invention is also directed to a system for the merging and transformation of the engineering rule sets into a document object model for use within a standard web browser component. A method for authoring the engineering rule set via natural language editing is also provided. The present invention also provides a method for the extension and automation of an engineering system via a network-capable customization agent consisting of functional rules and integration of standardized technologies.

### BACKGROUND OF THE INVENTION

1. Field of the Invention

The present invention is directed to a method and apparatus for the interpretation and navigation of operations and data in an engineering system via representations of end-user goals and tasks.

2. Description of the Background

A broad definition for a wizard could include a form of user assistance that automates a task through a dialogue with the user. However, the typical embodiment of a wizard is as a hard-coded user interface consisting of a series of property sheets. In general, an application gives control to a wizard; the wizard drives the application to perform a sequence of operations given user input inside the wizard.

Operations and data exposed via a user interface of an engineering system do not necessarily correspond to end-user goals and tasks. For example, a user may think of a task as “define a load”, but to accomplish that task the system must expose a variety of supporting operations and data items. Prior approaches to addressing this disconnect took two forms. The first form, documentation, requires the user to manually interpret their goals and tasks in terms of the engineering system. This approach demands significant effort from the user not directly related to the advancement of their goal or task. This approach also demands a level of expertise and familiarity for user confidence in their interpretation.

Second, alternative user interfaces (such as wizards) attempt to make user goals apparent by exposing only a subset of options, typically in discreet sequential steps. However, engineering problems often do not always fit such simplified models. The approach breaks down when the user's task requirements exceed the scope of the wizard design, i.e. to accomplish the task the user must forego the simpler alternative or use both and learn how they interrelate. Moreover, by replacing or hiding elements of the standard user interface, the approach makes it more difficult to graduate to the standard interface or to collaborate with users of the system not familiar with the alternative interface.

Customization of engineering system user interface has been impossible or required advance programming using proprietary techniques. Accordingly, the need exists for an assistance layer between the core system and end-user that facilitates interpretation, navigation and customization capabilities.

### SUMMARY OF THE INVENTION

The present invention may be thought of as a rules-based task browser or a rules-based user assistant and customization agent for engineering systems. The present invention interprets a rule set to respond interactively to events in the application, and provides navigation to and information about tools and data in the application, instead of providing an alternative interface. The present invention may also take input and drive the application.

The present invention is also directed to a system for the merging and transformation of the engineering rule sets into a DOM (Document Object Model) for use within a standard web browser component. A method for authoring the engineering rule set via natural language editing is also provided. The present invention also provides a method for the extension and automation of an engineering system via a network-capable customization agent consisting of functional rules and integration of standardized technologies.

The present invention provides several advantages. It broadens the appeal of the engineering system by enabling on-demand in-context feedback and assistance. The present invention is scalable from beginner or expert user experience levels, it is scalable from basic to advanced functionality, and it is application to new and legacy data. The present invention encourages user exploration and graduation to more advanced usage levels. The present invention maximizes exposed capabilities, efficiency, consistency and clarity of the standard engineering system user interface. The present invention minimizes development, testing, documentation and support costs for building and maintaining the engineering system. The present invention allows low-investment integration of expertise and best practices information along with access to network resources into the engineering system by domain experts (non-developers) and facilitates standards-based, distributed, customization and vertical application development. The present invention opens business opportunities for web applications/services built on top of an engineering system.

### BRIEF DESCRIPTION OF THE DRAWINGS

For the present invention to be easily understood and readily practiced, the invention will now be described, for purposes of illustration only, in connection with the following figures wherein:

FIG. 1 summarizes the user interaction architecture;

FIG. 2 is a comparison of the present invention with a standard web browser;

FIG. 3 illustrates the present invention in a distributed network configuration;

FIG. 4 illustrates a system overview;

FIG. 5 illustrates a summary of components;

FIG. 6 illustrates a connectivity diagram;

FIG. 7 illustrates a resource diagram;

FIG. 8 illustrates a TaskML file load overview;

FIG. 9 illustrates a TaskML linking;

FIG. 10 illustrates the structure of the task browser architecture;

FIG. 11 illustrates the structure of the TaskML vocabulary;

FIG. 12 diagrams basic conditional statement logic;

FIG. 13 diagrams basic action statements;

FIG. 14 illustrates logic supporting a rules system;

FIG. 15 illustrates a TaskML load/merge process;

FIG. 16 illustrates a browser Document Object Model (DOM) build process;

FIG. 17 illustrates a process by which rules generate functional tasks;

FIG. 18 illustrates an engineering system and task browser;

FIG. 18A illustrates a standard user interface and conceptual assistance layer; and

FIGS. 19-33 are various screenshots useful in illustrating various features of the present invention.

### DESCRIPTION OF THE PREFERRED EMBODIMENT

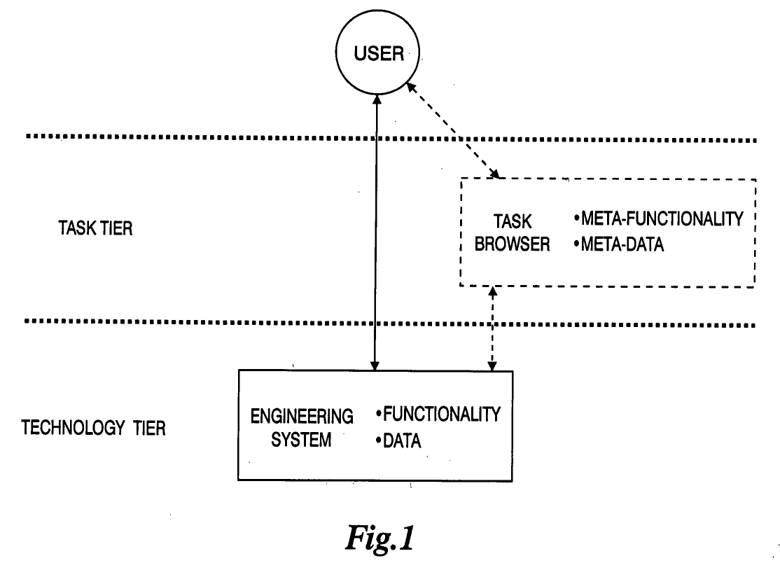

In FIG. 1, the user interacts with the engineering system directly and may interact with the engineering system via the task browser. Conceptually, the engineering system occupies a “Technology Tier” in which functionality and data are exposed in the most efficient, consistent and flexible way possible.

The task browser occupies an optional “Task Tier” between the user and the engineering system. The task browser exposes “meta-functionality” and “meta-data” in terms of functionality and data in the engineering system, but does not replace or redefine aspects of the engineering system.

Benefits of this architecture include:

on-demand assistance for performing tasks in the engineering system are always available for novice or expert users in context of the current state of the engineering system. Users may “graduate out of” the Task Tier into direct use of the Technology Tier;

the Technology Tier is unaffected by the Task Tier, therefore the engineering system design may focus on power, efficiency and flexibility; and

customization at the Task Tier does not modify the Technology Tier, improving overall reliability and lowering customization overhead.

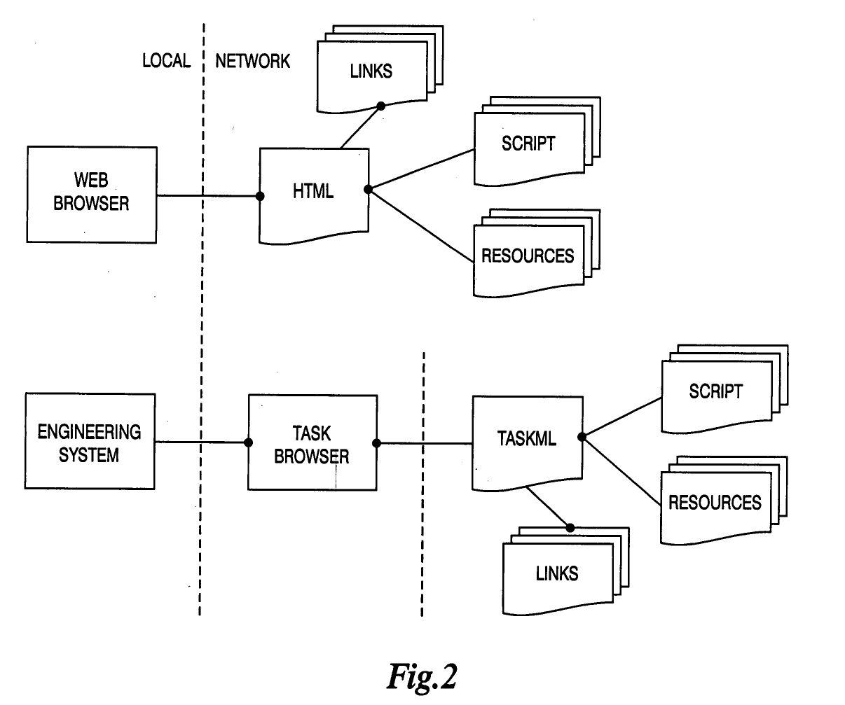

FIG. 2 compares the task browser versus standard use of a web browser. A web browser and an engineering system are both client software applications.

At the top of FIG. 2, the web browser loads an HTML file from a network location. The HTML file may reference script files and other resources. The HTML file may provide links to network resources (hyperlinks).

At the bottom of FIG. 2, the Engineering System loads the task browser from a network location. The task browser in turn loads a TaskML file from a network location in the same way as a web browser loads an HTML file. Similarly, the TaskML file may reference script files and other resources, and may provide links to network resources. In all cases, network resources may also be local.

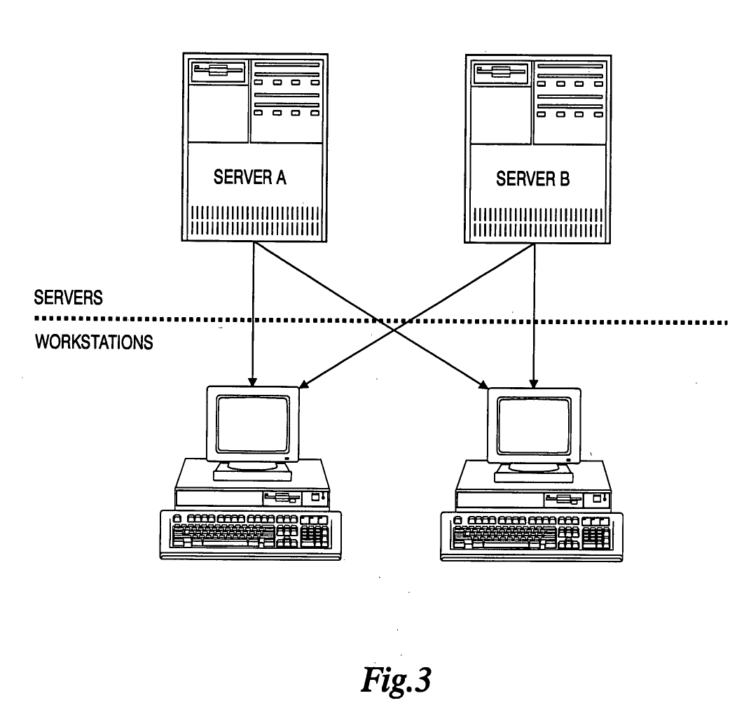

FIG. 3 shows how the task browser system supports network customization and extensibility.

Workstations run the engineering system.

The engineering system runs a customized task browser system from Server A.

The task browser system opens custom TaskML files from Server B.

Note that the connections shown above may also occur intra-machine or between workstations.

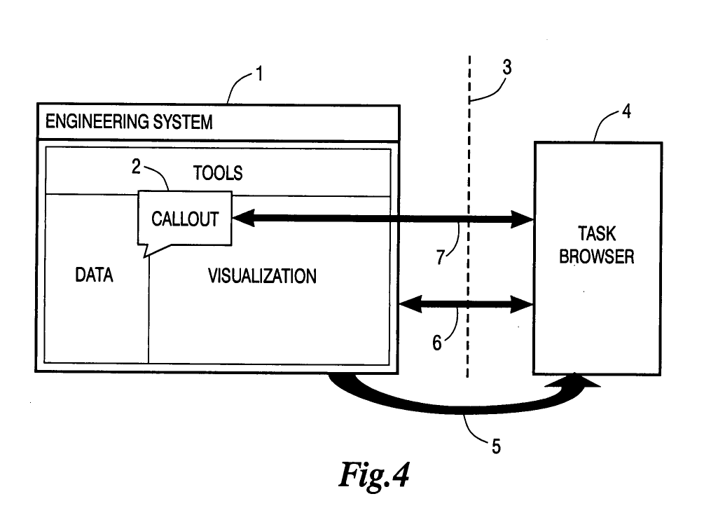

FIG. 4 shows high-level components and connectivity of the system.

Engineering System (1)—a client software application used to browse, edit and generate engineering information.

Callout (2)—a visual interface component used to provide information and interaction in context of a particular “location” within the Engineering System. “Location” means not only screen coordinates but the state of and selections in the engineering system. (Note that other methods exist for indicating locations within an application.)

Application Boundary (3)—components across the boundary may exist locally or at an arbitrary network location

Task Browser (4)—a web application running in conjunction with the engineering system. (In the preferred embodiment the task browser is implemented with web technologies but it may be desirable in some applications for the task browser to be implemented not using web technologies.)

Events (5) flow in one direction, from the engineering system to the task browser. As such the task browser responds to arbitrary actions in the engineering system.

Engineering System (1) to Task Browser (4) Connectivity (6)—described below.

Task Browser (4) to Callout (2) Connectivity (7)—the task browser (4) drives the Callout (2). Once initialized, the Callout (2) may drive the task browser (4). The engineering system (1) may connect to the Callout (20 via the task browser (4).

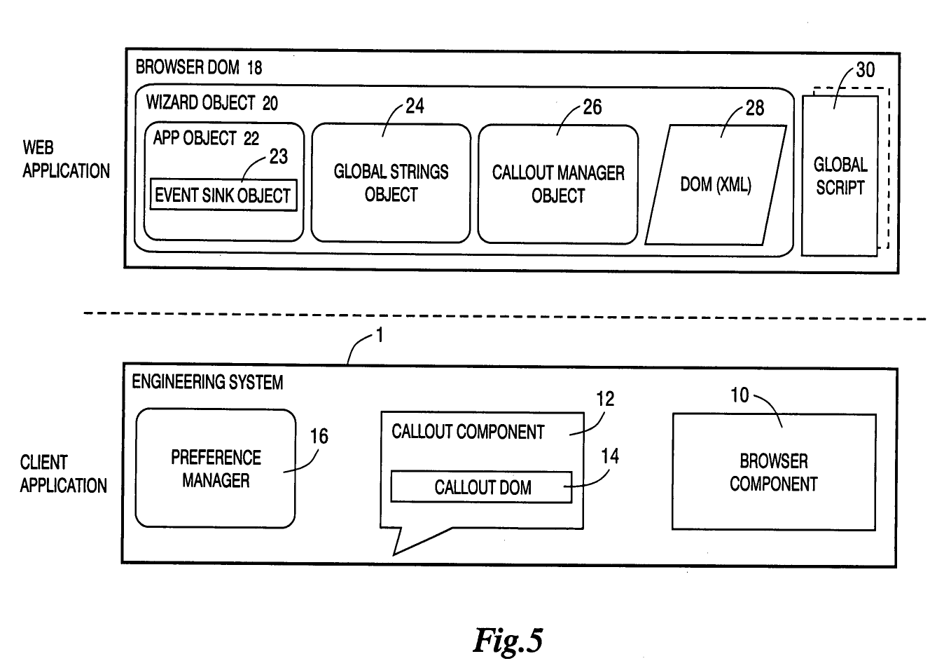

FIG. 5 illustrates a preferred embodiment. Note that not all components of the system are shown for purposes of simplifying the presentation.

Client Application (the Engineering System):

Browser Component (10)—a standard web browser component (e.g. Microsoft Internet Explorer) hosted inside the engineering system (1) (e.g. as an ActiveX control).

Callout Component (12)—user interface control provided by the engineering system (1). The Callout Component (12) contains a second browser component.

Callout DOM (14)—Document Object Model exposed by the Callout browser component.

Preference Manager (16)—manages and exposes user settings, provided by the engineering system (1).

Web Application (the Task Browser):

Browser DOM (18)—Document Object Model exposed by the Browser Component (10) hosted by the engineering system (1). The Browser DOM (18) initially contains a bootstrap HTML file. The bootstrap file executes code to construct the web application.

Task Browser (Wizard) Object (20)—master object that controls the Task Browser.

App Object (22)—manages connections to the engineering system (1).

Event Sink Object (23)—handles events from the engineering system (1).

Global Strings Object (24)—manages localized global strings for display by the web application.

Callout Manager Object (26)—manages operation of the Callout inside the engineering system (1).

DOM (28)—contains the current merged TaskML.

Global Script (30)—code inside the Browser DOM (18) that is not part of an object.

Callouts provide a mechanism for delivering information and interactivity in context and in specific locations within the application. Callouts differ from traditional tooltips (infotips) in that they provide rich content in a well-defined context and do not time out. A callout is a floating, modeless window positioned overtop of the standard user interface (UI). The leader of the callout points directly at a particular control or location of interest.

The window contains a browser that displays HTML. The HTML may:

Display text, small images, hyperlinks (e.g. to the main help system), options or buttons.

Execute script to communicate with the application.

The basic Callout window may have the following characteristics:

A browser area with margin. Margin default=2 pixels.

A fixed width. Default to around 200 pixels.

An auto-sizing height based on height of browser content.

A leader, positioned on a side pointing outwards. Leader dimensions default to 12 pixels.

A prominent border. Default=1 pixel black.

Solid background color. Default=Windows “infobackground” or “tooltip” for consistency with the operating system.

Callouts may contain two standard buttons (as part of the HTML page):

X—used to explicitly close the Callout window. Clicking any location inside that Callout that isn't occupied by a control also closes the window.

A symbol-used as a shortcut to toggle the Enable Callouts button in the standard toolbar. This button is hidden when the Browser is active.

Any application window move or resize event (including splitters) must hide the Callout window to prevent the Callout from targeting an invalid location. Following the event the Callout should reappear in an updated location.

A callout always “targets” a particular control inside the application window. The following sections list the minimum required targets. (Theoretically, callouts can target any arbitrary location.) Callouts may target any object within a hierarchical structure. The leader points upwards to the bottom right corner of the object's label. Callouts may target any field within a properties list. The leader points downwards to the top of the column split. Callouts may target any button on any toolbar. The leader points upwards a few pixels into the bottom center of the button. Callouts may target any tab. The leader points downwards a few pixels into the top center of the tab.

Callouts provide default messages for property fields based on the selected field's type. This default message may be overridden for specific fields for specific objects.

Geometry Fields—message may read:

Modify the geometry selection, then click Apply. Click Cancel to keep the existing selection.

Decisions—message may read:

Click the arrow the choose from a list of alternatives. Your choice may change the available items listed below.

Numbers—messages for numbers may include min and max values and a note about the input parameter checkbox.

Direction Fields—message may read:

Choose a direction by selecting a planar face, a cylinder, a straight edge, two vertices or any arrow on the coordinate system triad. Click Cancel to keep the existing direction.

Options—message may read:

Click the arrow to choose from a list of options. Check the box beside the name to make this item an input parameter.

Read-Only—May include a note about copying numbers by pressing Ctrl+C and a note about the output parameter checkbox.

Text—free text field.

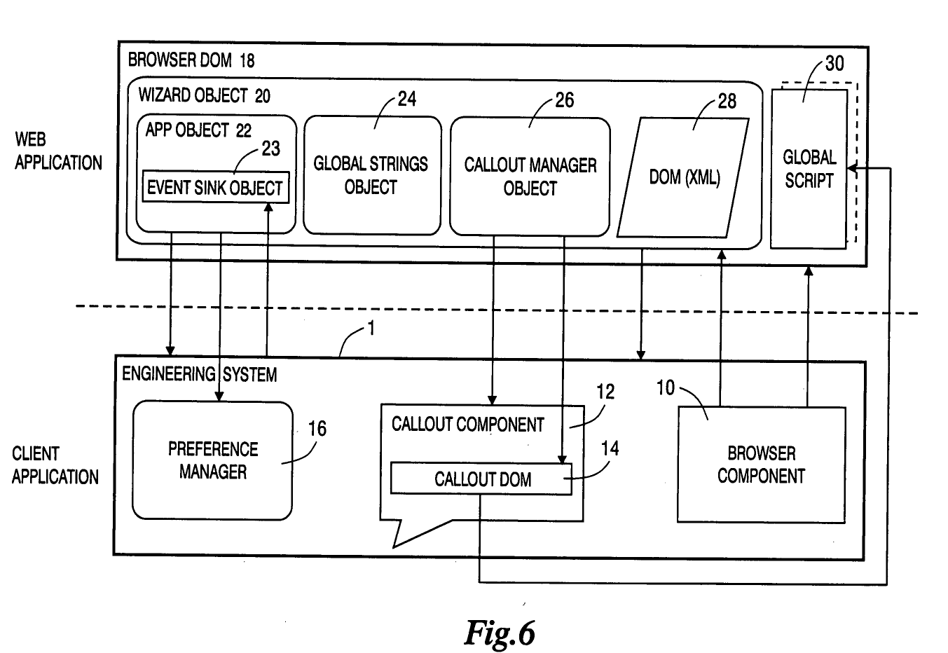

FIG. 6 shows how the various components of the system connect. Objects automatically connect to objects they contain. This diagram does not show all possible connections.

App Object (22) accesses various components of the engineering system (1).

App Object (22) accesses the Preference Manager (16).

The Event Sink Object (23) receives events fired by the engineering system (1).

The Callout Manager Object (26) accesses the Callout Component (12).

The Callout Manager Object (26) accesses the Callout DOM (14).

The Wizard Object (20) has access to various components of the engineering system (1).

The Browser Component (10) has access to the Wizard Object (20).

The Browser Component (10) has access to the Browser DOM (18). This connection provides the initial reference used to connect the web application to the engineering system (1).

The Callout DOM (14) may access Global Script (30) inside the Browser DOM (18).

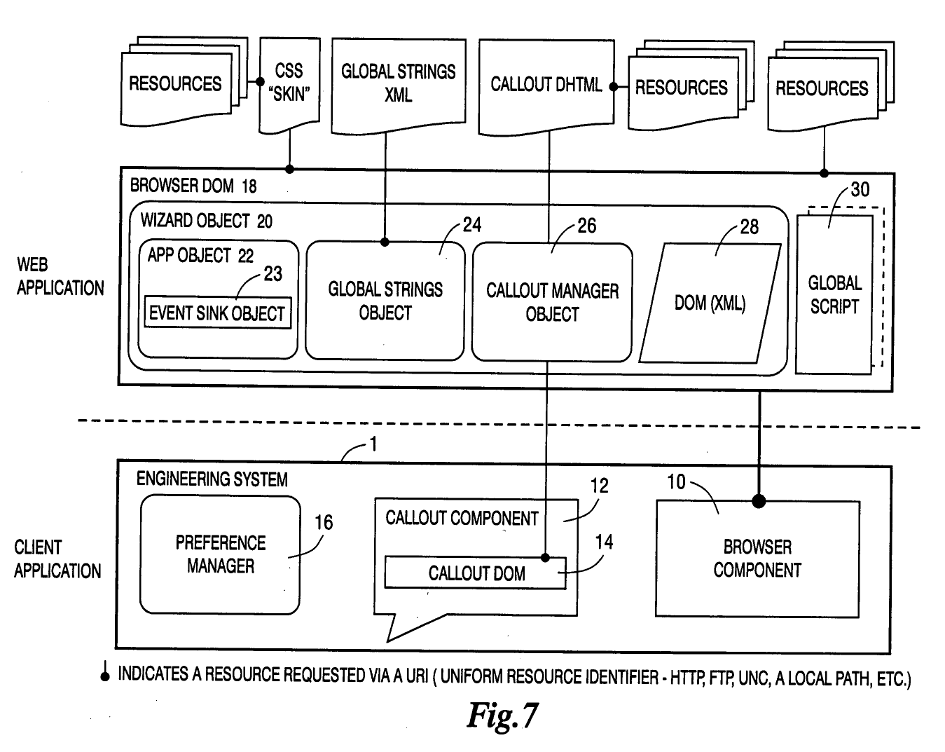

FIG. 7 shows how components of the Task Browser may be distributed over a network using web linking. The link to note is the one between the Browser Component (10) in the engineering system (1) and the Browser DOM (18) in the web application. This link allows the engineering system (1) to load the task browser from any URI (local or network).

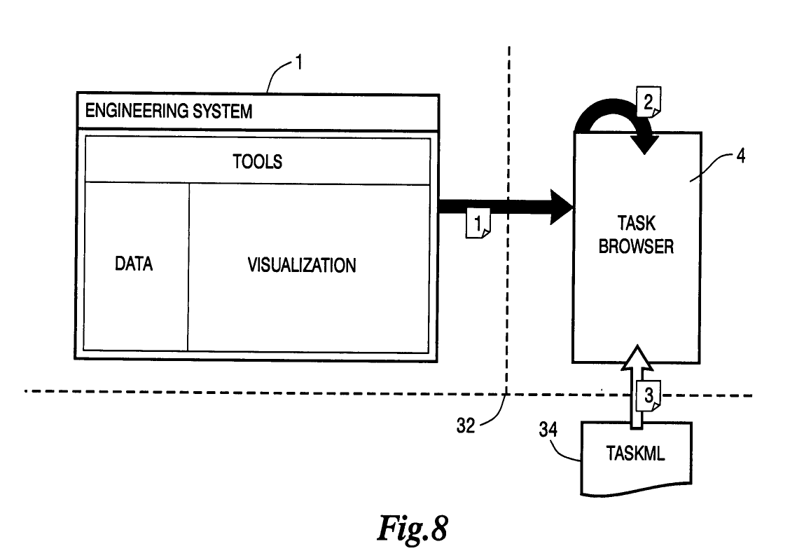

FIG. 8 shows the high-level process of loading TaskML into the Task Browser (4). Potential network boundaries are represented by the numeral 32.

1—The engineering system (1) may direct the task browser (4) to load a specific TaskML file (34). By default, TaskML files (34) exist in the same location as the task browser (4), but they may exist in any location accessible via a URI.

2—The task browser (4) may expose an option to allow the user to choose a TaskML file (34).

3—When instructed to load a TaskML file (34) the task browser (4) loads the TaskML file (34) via a URI and initiates the merge process.

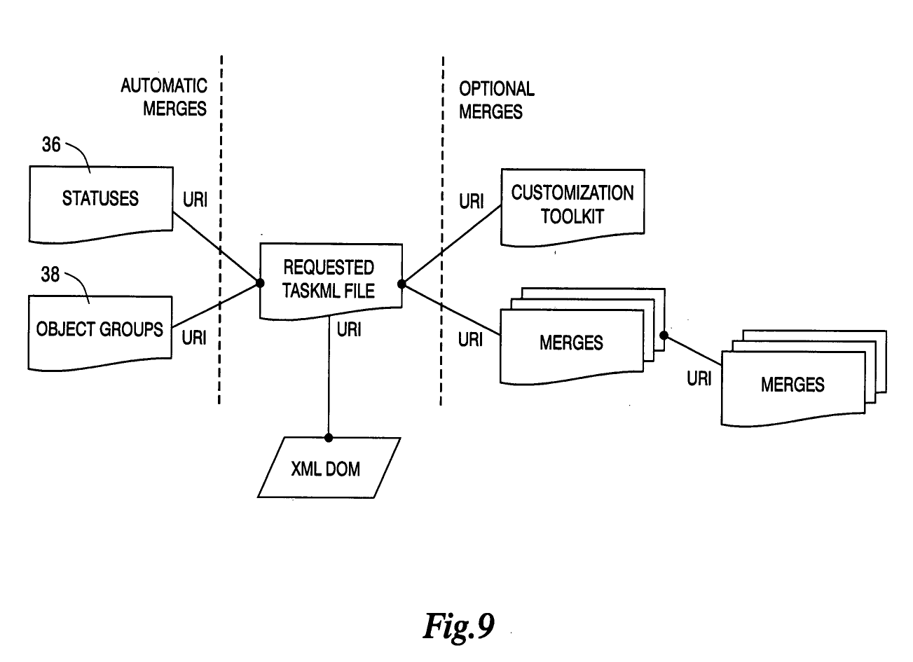

FIG. 9 shows how a TaskML file may link to multiple components distributed over a network. A selective process referred to as “merging” builds a composite DOM from referenced TaskML files during the load process. The task browser (4) uses this merged DOM as if it were originally one TaskML file. This structure allows:

Access to a TaskML file by multiple clients from a network location.

Reuse of TaskML components by multiple TaskML files.

Two special TaskML components are merged automatically as part of the standard task browser system:

Statuses (36)—connects the statuses that may be set for a task (e.g. “Complete”) with the status visual representation defined in the skin (CSS). Statuses (36) may represent the state of the task given conditions in the engineering system or may represent special operations performed by the task. Statuses may be customized via the merge process.

Object Groups (38)—defines meaningful groups of objects available inside the engineering system for use by task rules. For example, the group “structural load” contains references to many unique objects inside the engineering system. Object Groups (38) may be customized via the merge process.

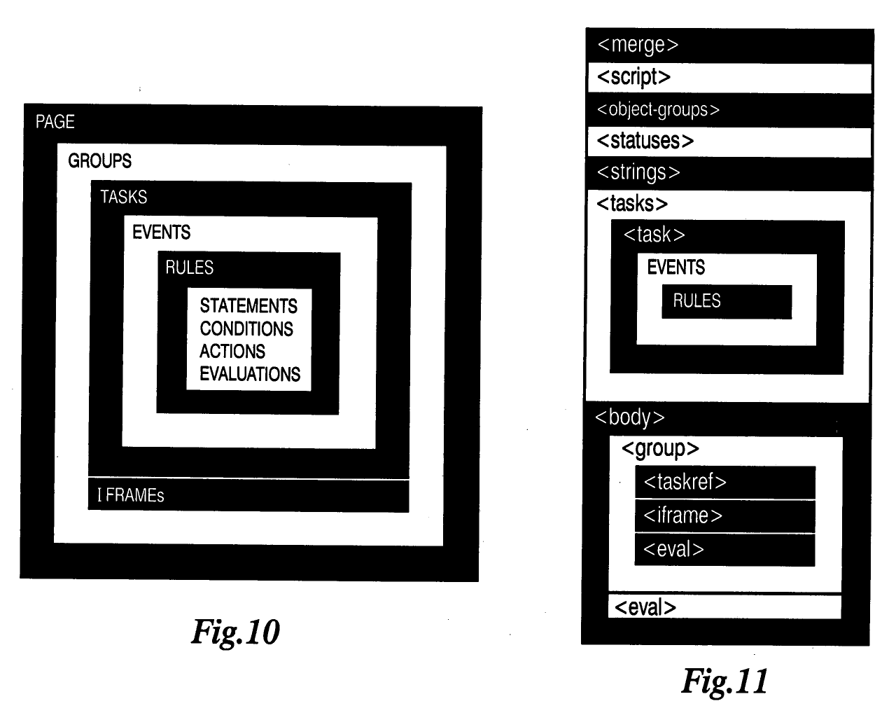

FIG. 10 shows conceptual “layers” of the task browser architecture.

Page—content displayed inside the task browser.

Group—for organization the Page is presented in groups. A group contains Tasks and/or IFRAMEs

Task—represents an operation or set of operations that the user may want to perform in the course of using the engineering system (1). The task displays a caption describing its purpose and an icon representing status or the purpose of the task. Tasks are presented in order within the Page and may collectively represent a procedure or steps in a process.

Event—a Task may define events. Events specify the behavior of the Task given an event inside the engineering system (1) or due to a user action.

Rule—a sequence of predefined actions the Task performs when the Event occurs. Rules consist of statements, conditions and/or evaluations, and are encoded in the TaskML XML vocabulary which may be visualized as English sentence fragments.

Statement—a TaskML tag used to control logic and flow within an Event.

Condition—a TaskML tag that tests a condition inside the engineering system (1) and returns a value.

Action—a TaskML tag that performs an operation and returns a value that may be used as a condition.

Evaluation—a TaskML tag that causes the task browser to evaluate code specified by the tag. Evaluation provides the ability to customize/extend the task browser system beyond the scope of the defined tag vocabulary. Evaluation may return a value to use as a condition.

IFRAME—(an HTML “Inline Frame”) represents arbitrary web browser content (e.g. a web page) inserted inside a group. IFRAMEs allow the Page to be customized with arbitrary content and user interface controls.

FIG. 11 illustrates the basic architecture of the TaskML XML vocabulary.

Merge—references a TaskML file

Script—references a script file

Object Groups—defines groups of objects

Statuses—defines task status conditions

Strings—defines strings displayed by the task browser

Tasks—contains task definitions

Body—defines what the page displayed by the task browser contains

Group—defines a group inside the page

Taskref—references a task

IFrame—references external content to insert into the group

Eval—causes the task browser to evaluate code during page generation

In addition to a display name, a task definition supports the following functions:

How to determine its status

How to automate the application when the task is activated (clicked)

Tasks use a rules-based system for status checking and automation. A rules-based system allows for easy, high-level customization of Task Browser content, usually without the need for any programming.

A Rule usually consists of two parts:

A conditional statement, expressed in English, as an “If . . . Then” sentence fragment.

Action statements, expressed as English sentences.

The conditional statement may be omitted if the rule specifies default actions.

As an example, the following simple rule causes a task to display the “complete” status icon when a Geometry object exists in the same branch as the currently selected object in the Outline:

If object type GEOMETRY exists then:

1. Set task status to complete.

The underlined text represents choices made to define the rule. Clicking the underlined text usually displays a simple list of alternatives.

Expressing the rule in XML yields:

<status-check>

<if><object type=”GEOMETRY” state=”exists” /></if>
<then><set-status-to status=”complete” /></then>

</status-check>

XML provides a bridge between the author's intent (expressed in English sentences) and the workings of a version of the software (expressed in the underlying script). The rule statements as encoded in XML are processed at run-time by general-purpose script functions.

A task function usually uses a number of rules in succession. For example, to completely define the status of the task “Insert Geometry” four rules are required:

If Model-level is ambiguous then:

1. Set task status to indeterminate.

If object type GEOMETRY does not exist and object type MODEL is selected then:

1. Set task status to in progress.

If object type GEOMETRY does not exist then:

1. Set task status to incomplete.

If object type GEOMETRY exists then:

1. Set task status to complete.

Rules are processed in order, top-down. If a rule's condition is met, its actions are performed and the function finished. No further rules are checked. Typically, the most specific rules occur first followed by more general rules.

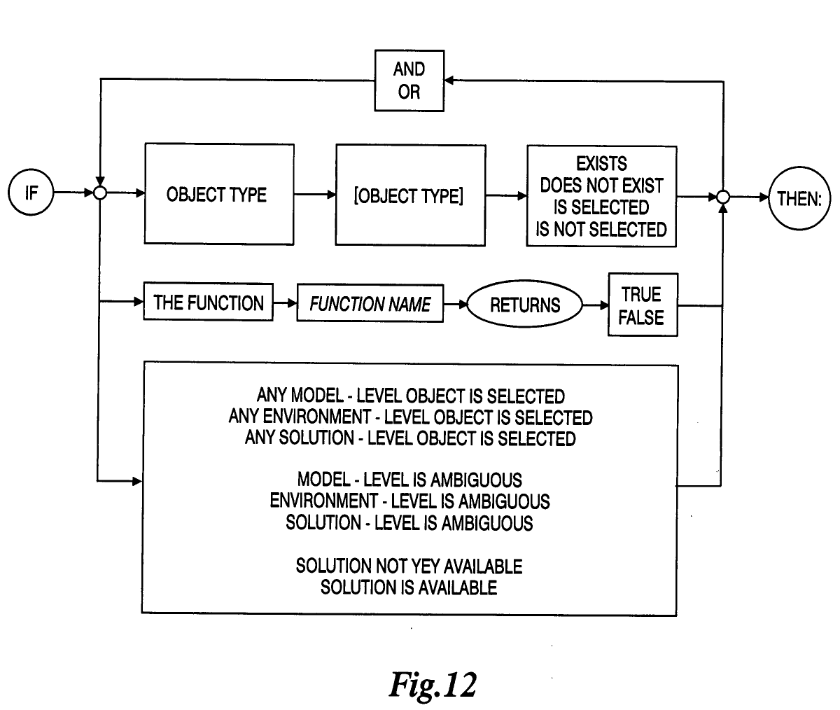

FIG. 12 diagrams the conditional statement logic set forth above. Each underlined group of words in the statement corresponds to a rectangle in this diagram.

Conditions are determined by the following:

Test for existence of a type of object within the branch of the currently selected object.

Test for the type of object currently selected.

High-level predefined criteria.

Return value from a script function.

The action statements perform some automation of the application when the task is clicked. In the previous examples the action was “Set task status to . . . ”. This action controls the icon and appearance of a task within the Browser. Other actions perform the following:

Select the first instance of a type of object within the branch of the currently selected object. If an object of that type is already selected no action occurs.

Select a field in an object's Details by name.

Display a Callout with a particular message pointing at an object, a field, a toolbar button or a tab.

Open the Help system and display a particular topic.

Open a browser window and navigate to a particular URL.

Execute a script function.

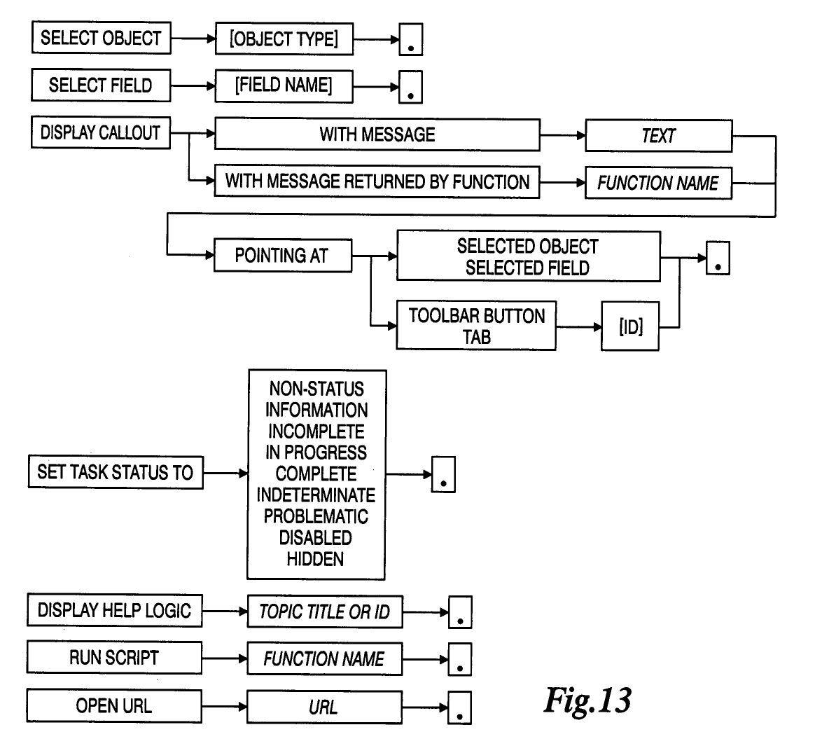

FIG. 13 details those basic action statements.

The following code shows a template for the XML representation for all conditions and actions defined by the preceding diagrams:

<task name=”Display Name”>

<status-check>

<if>

<object type= “GEOMETRY | MODEL | etc” state= “exists | is

selected | etc” />

<and />
<function name= “Function Name” return-value= “true | false” />
<model-level-selection /><environment-level-selection

/><solution-level-selection />

<model-level-ambiguous /><environment-level-ambiguous

/><solution-level-ambiguous />

<solution-not-available /><solution-available />

</if>
<then>

<set-status-to status= “incomplete | in progress | complete | etc” />

<then>
<!− default action goes here −−>

</status-check>
<activation>

<if><!−− (same as above) −−></if>
<then>

<select-object type= “GEOMETRY | MODEL | etc” />
<select-field name= “Magnitude | etc” />
<display-callout>

<message function= “Function Name”>HTML

Code</message />

<outline />
<details />
<toolbar-button id= “INSERT GEOMETRY | etc” />
<tab name= “design | print | report | help” />

</display-callout>
<display-help-topic id= “Toic Title or ID” />
<run-script function= “Function Name” />
<open-url href= “http | ftp | mailto | unc | local” />

</then>
<!- default action goes here−−>

</activation>

</task>

For the Task-Insert Geometry set forth above, the “Activation” would be:

If object type PROJECT is selected then:

1. Display callout with message “message1” pointing at toolbar button INSERT GEOMETRY.

If object type GEOMETRY does not exist then:

1. Select object MODEL.

2. Display callout with message “message2” pointing at toolbar button INSERT GEOMETRY.

If object type GEOMETRY exists then:

1. Select object MODEL.

2. Display callout with message “message3” pointing at toolbar button INSERT GEOMETRY.

Other examples of natural language expressions of tasks are:

Task: Assign Material

Status Check

If Model-level is ambiguous then:

1. Set task status to indeterminate.

If object type GEOMETRY does not exist then:

1. Set task status to disabled.

If object type GEOMETRY exists and object type PART is selected then:

1. Set task status to in progress.

If object type GEOMETRY exists then:

1. Set task status to complete.

Activation

If Model-level is ambiguous then:

1. Select object MODEL.

2. Display callout with message “To use this task first select a Model.” pointing at selected object.

If object type PART exists then:

1. Select object PART.

2. Select field MATERIAL.

3. Display callout with message “message” pointing at selected field.

Task: Insert Structural Load

Status Check

If Environment-level is ambiguous then:

1. Set task status to indeterminate.

If object type ENVIRONMENT does not exist then:

1. Set task status to disabled.

If object type STRUCTURAL LOAD does not exist then:

1. Set task status to incomplete.

If object type STRUCTURAL LOAD is selected then:

1. Set task status to in progress.

If object type STRUCTURAL LOAD exists then:

1. Set task status to complete.

Activation

If Environment-level is ambiguous then:

1. Select object ENVIRONMENT.

2. Display callout with message “To use this task first select an Environment.” pointing at selected object.

If any Environment-level object is selected then:

1. Display callout with message “message” pointing at toolbar button STRUCTURAL LOAD.

If object type ENVIRONMENT exists then:

1. Select object ENVIRONMENT.

2. Display callout with message “message” pointing at toolbar button STRUCTURAL LOAD.

Task: Insert Displacement Load

Status Check

If Environment-level is ambiguous then:

1. Set task status to indeterminate.

If object type ENVIRONMENT does not exist then:

1. Set task status to disabled.

If object type DISPLACEMENT LOAD does not exist then:

1. Set task status to incomplete.

If object type DISPLACEMENT LOAD is selected then:

1. Set task status to in progress.

If object type DISPLACEMENT LOAD exists then:

1. Set task status to complete.

Activation

If Environment-level is ambiguous then:

1. Select object ENVIRONMENT.

2. Display callout with message “To use this task first select an Environment.” pointing at selected object.

If any Environment-level object is selected then:

1. Display callout with message “message” pointing at toolbar button DISPLACEMENT LOAD.

If object type ENVIRONMENT exists then:

1. Select object ENVIRONMENT.

2. Display callout with message “message” pointing at toolbar button DISPLACEMENT LOAD.

Task: Solve

Status Check

If Solution-level is ambiguous then:

1. Set task status to indeterminate.

If object type SOLUTION does not exist then:

1. Set task status to disabled.

If solution not yet available then:

1. Set task status to incomplete.

If solution is available then:

1. Set task status to complete.

Activation

If Solution-level is ambiguous then:

1. Select object SOLUTION.

2. Display callout with message “To use this task first select a Solution.” pointing at selected Outline object.

If solution not yet available then:

1. Display callout with message “message” pointing at toolbar button SOLVE.

If solution is available then:

1. Select object SOLUTION.

2. Display callout with message “message2” pointing at selected Outline object.

Task: View Results

Status Check

If Solution-level is ambiguous then:

1. Set task status to indeterminate.

If object type SOLUTION does not exist then:

1. Set task status to disabled.

If object type RESULT does not exist or solution not yet available then:

1. Set task status to incomplete.

If object type RESULT is selected then:

1. Set task status to in progress.

If object type RESULT exists then:

1. Set task status to complete.

Activation

If Solution-level is ambiguous then:

1. Select object SOLUTION.

2. Display callout with message “To use this task first select a Solution.” pointing at selected Outline object.

If object type RESULT does not exist then:

1. Select object SOLUTION.

2. Display callout with message “message” pointing at toolbar button STRESS RESULTS.

If solution not yet available then:

1. Display callout with message “message2” pointing at toolbar button SOLVE.

If object type RESULT exists then:

1. Select object RESULT.

2. Display callout with message “message3” pointing at selected object.

Task: View Report

Status Check

Set task status to non-status.

Activation

Display callout with message “message” pointing at tab REPORT.

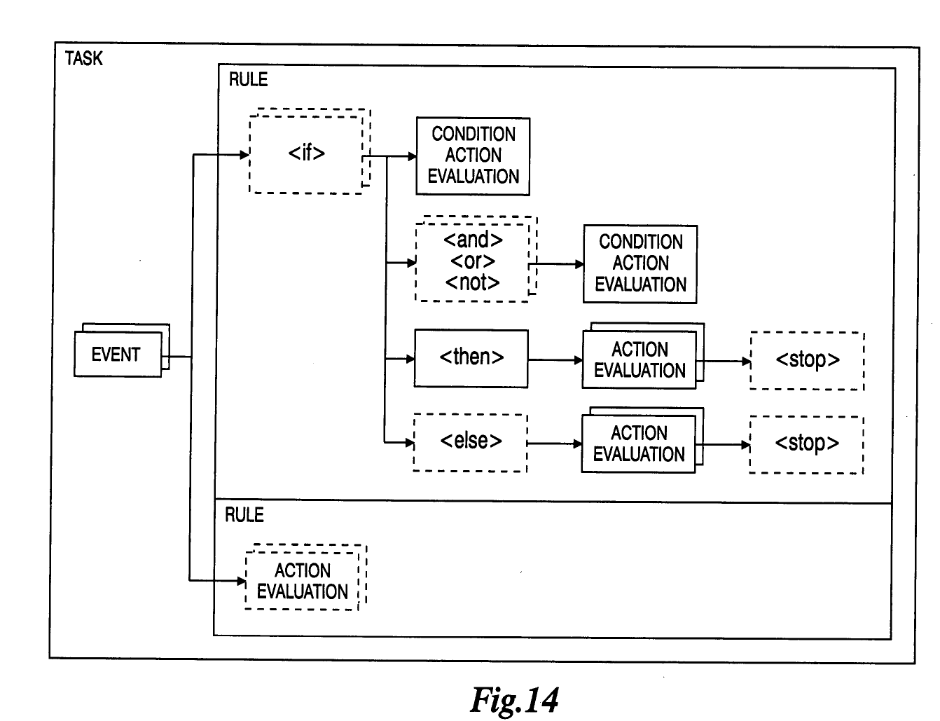

FIG. 14 shows the logic supporting the rules system. A task may define multiple events. If no events are defined then the task is not interactive. Two standard events are Update (e.g. something occurred in the engineering system that causes tasks to redetermine their status) and Activate (e.g. the user clicked the task). An event contains a sequence of rules. As previously stated, Rules consist of <if> statements, actions or evaluations.

<if> statements must contain one condition, action or evaluation.

<if> elements may also contain one or more <and> or <or> statement. <and> or <or> statements must contain one condition, action or evaluation.

Conditions, actions or evaluations may be contained in a <not> statements to invert their Boolean return value.

<if> statements must contain one <then> statements. A<then> statements must contain one or more actions or evaluations. A<then> statements may conclude with a <stop> statements if the event should not process further rules.

<if> statements may include one <else> statements following the <then> element.

The XML Element column below shows the syntax for TaskML rules (without showing defaults, optionals or sample data). The Sentence Fragments column shows natural language equivalents used for editing and viewing TaskML data. The user may manipulate sentence fragments indicated by a continuous underline.

Statements

| XML Element | Sentence fragments |
|---|---|
| <if></if> | If |
| <ard></and> | and |
| <or></or> | or |
| <not></not> | not |
| <then></then | Then (begin numbered list) |
| <else></else> | (begin numbered list) |
| <stop/> | |
| <debug/> | |

Conditions

| XML Element | Sentence Fragments |
|---|---|
| <level type= ″″ condition=″″/> | the Outline level ″″″″ |
| <object type= ″″ condition=″″ state=″″ name- | an Outline object name ″″ of type ″″ with state ″″ ″″ |
| regexp=″″/> | |
| <changeable-length-unit/> | the geometry length unit can be changed |
| <assembly-geometry/> | the geometry contains an assembly |
| <geometry-includes-sheets/> | the geometry includes one or more sheets |
| <zero-thickness-sheet/> | the geometry includes any zero-thickness sheets |

Actions

| XML Element | Sentence Fragments |
|---|---|
| <set-icon src= ″″/> | Set the task icon to the URL ″″ |
| <set-caption caption= ″″> | Set the task caption to the string ID ″″ |
| <set-status status = ″″/> | Set the task status to ″″ |
| <select-first-object type = ″″ state=″″ name-regexp= ″″/> | Select the first Outline object named ″″ of type ″″ |
| | with state ″″ |
| <select-all-objects type=″″ state=″″ name-regexp= ″″/> | Select all Outline objects named ″′ of type ″″ with |
| | state ″″ |
| <select-field name= ″″/> | Select the Details field named ″″ |
| <select-first-undefined-field/> | Select the first undefined Details field |
| <select-first-parameter-field/> | Select the first parameter Details field |
| <select-zero-thickness-sheets/> | Select all zero-thickness sheets |
| <click-button toolbar= ″″ button= ″″/> | Click the button ″″ on toolbar ″″ |
| <display-task-callout message= ″″/> | Display a callout pointing to this task with message |
| | ID ″″ |
| <display-outline-callout message= ″″/> | Display a callout pointing to the selected Outline |
| | object with message ID |
| <display-details-callout message= ″″/> | Display a callout pointing to the selected Details field |
| | with message ID ″″ |
| <display-toolbar-callout toolbar= ″″ button= ″″ | Display a callout pointing to the button ″″ on toolbar |
| message=″″/> | ″″ with message ID ″″ |
| <display-tab-callout tab= ″″ message= ″″/> | Display a callout pointing to the tab ″″ with message |
| | ID ″″ |
| <display-status-callout panel= ″″ message= ″″/> | Display a callout pointing to the statusbar panel ″″ |
| | with message ID ″″ |
| <open-url href= ″″/> | Open in a new web browser window the URL ″″ |
| <display-help-topic href= ″″ topic= ″″/> | Display Help from the URL ″″ and open the topic ″″ |
| <send-mail to= ″′ cc= ″″ bcc= ″″ subject= ″″ body= ″″/> | Compose an email to ″″ cc to ″″ bcc to ″″ with subject |
| | ID ″″ and default |
| <update/> | Fire an Update event here |
| <eval code= ″″/> | Evaluate the code ″″ |

The following is the XML rule set for the activation (via the mouse click event) of the “Assign Materials” task.

<activate-event>

<if>

<ambiguous-model-level/>
<then>

<display-task-callout message=“to use this task first select a

model”/>

<stop />

</then>

</if>
<select-all-objects type=“part” />
<select-field name=“Material” />
<display-details-callout message=“AssignMaterial_Message” />
</activate-event>

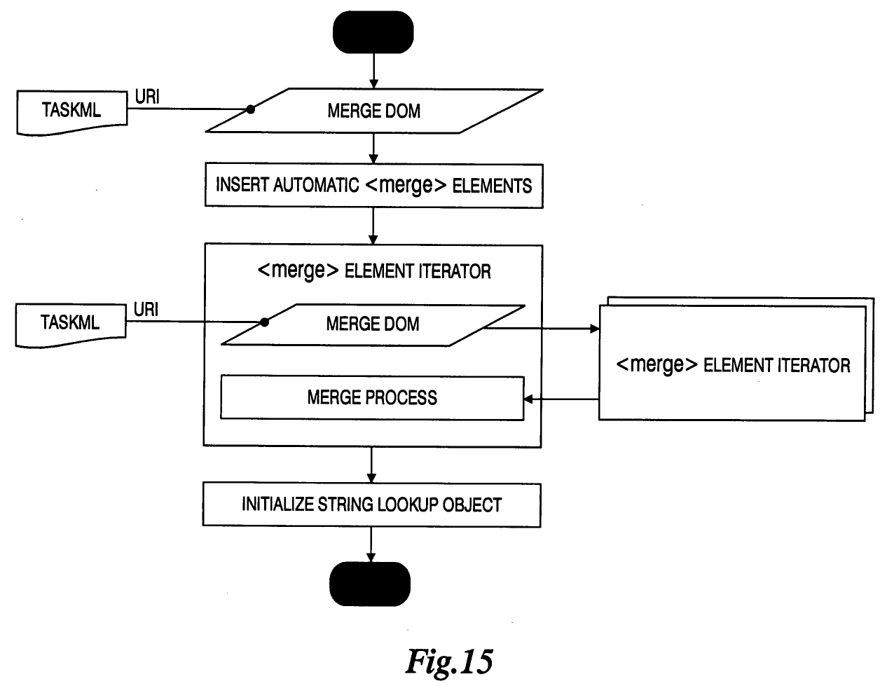

FIG. 15 shows the process for loading and merging TaskML into the Task Browser Object DOM.

(1) The load process is supplied with a URI to the master TaskML file. This URI may be selected automatically by the engineering system or chosen by the user.

(2) The master DOM loads the master TaskML file.

(3) Automatic <merge> elements are added to the master DOM.

(4)<merge> elements in the DOM are iterated.

(5) For each <merge> element a second DOM is loaded with the merged TaskML file.

(6) Step 4 is called (recursively) with the DOM from step 5.

(7) The merge process selectively adds elements from the merge DOM into the master DOM.

(8) When all <merge> elements in all TaskML files are processed, the string lookup object is initialized using the master DOM. (The string lookup object manages multiple-language strings.)

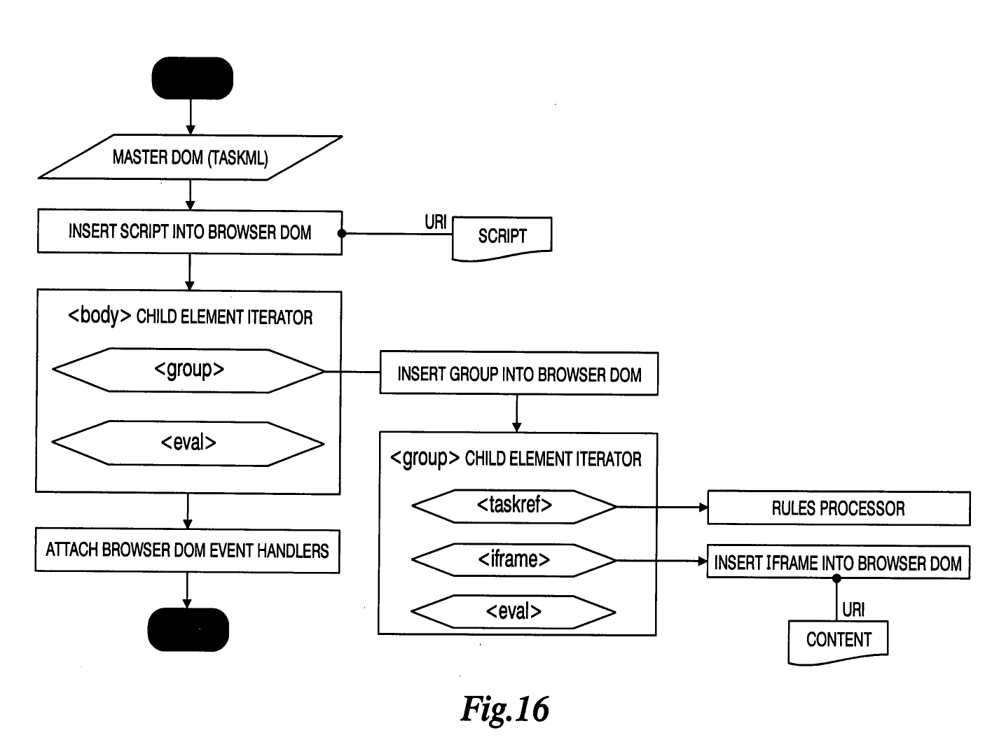

The master DOM is ready for use by the task browser (4). The task browser (4) proceeds to build the browser DOM as given in the FIG. 16.

FIG. 16 shows the process for constructing a browser DOM from TaskML. The browser DOM controls the appearance and behavior of all visual elements within the task browser (4).

For each <script> element in the master DOM a corresponding script element is inserted into the browser DOM. The browser automatically loads the corresponding script file. Script added in this way is available to the task browser as “global code”.

Child elements of the <body> in the master DOM are iterated. If the child is an <eval> the referenced code is immediately evaluated. If the child is a <group> then a group is constructed in the browser DOM.

Child elements of the <group> are iterated. If the child is an<eval> the referenced code is immediately evaluated. If the child is an<iframe> then an iframe is added to the browser DOM. The browser automatically loads the referenced content.

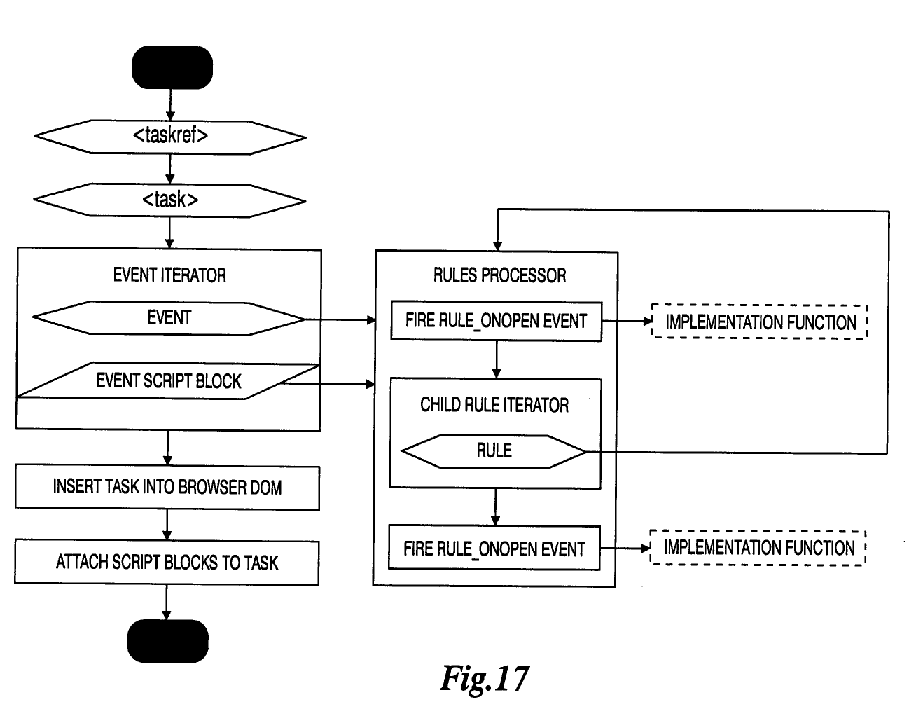

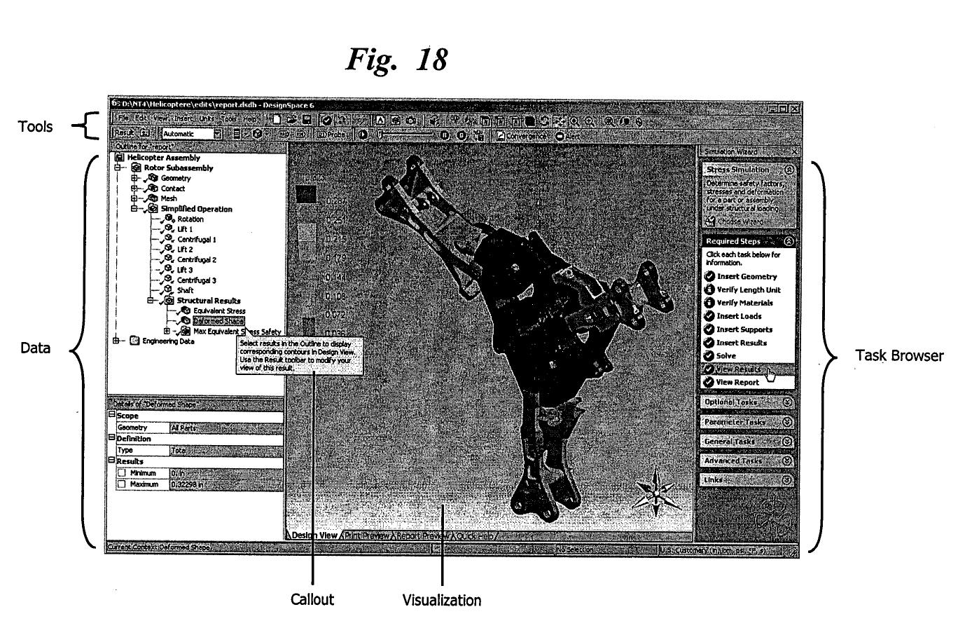

If the child is a <taskref> see FIG. 17.

FIG. 17 shows the process by which rules are processed to generate functional tasks.

The system looks up the <task> element corresponding to the current <taskref>.

Events inside the task are iterated. For each event the rules processor is called and supplied with the event element and a new script block object used to build virtual code for the task.

The rules processor fires an “onopen” event for the current element. This mechanism attempts to call a global function based on a naming convention. If implemented, this global function adds code to the script block object. (This mechanism allows for arbitrary customization by defining custom tags. Implementation functions for custom tags may be supplied in the <script> references of the TaskML file.)

Children of the current element are iterated. The rules processor is called recursively with the child.

The rules processor fires an “onclose” event for the current element analogous to the “onopen” event.

The task is inserted into the browser DOM.

Each script block is evaluated and attached to the task.

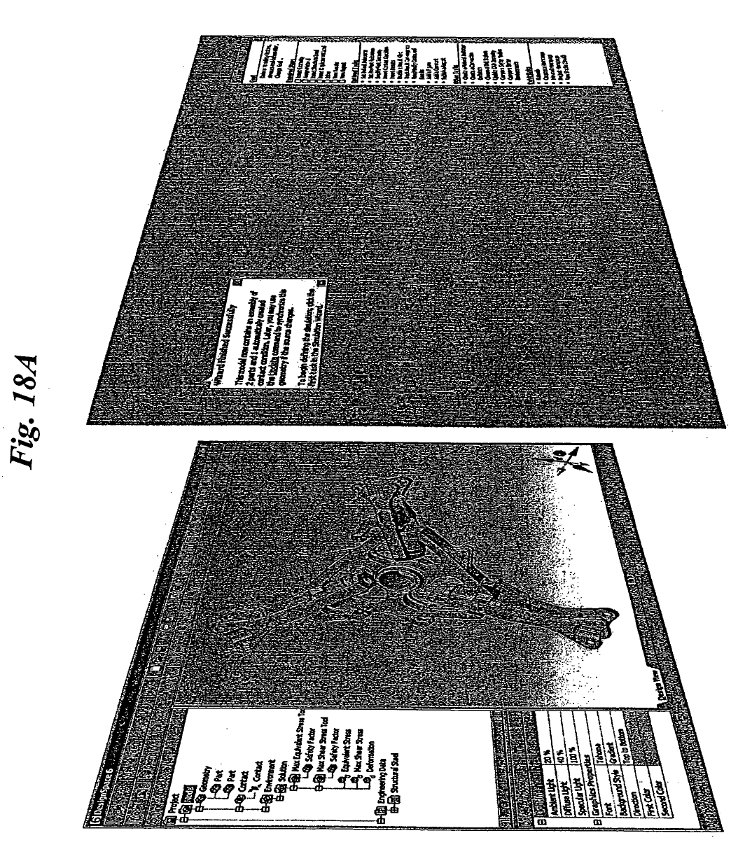

FIG. 18 is an image of an engineering system that shows how the task browser may render on an output device. FIG. 18A illustrates a standard user interface and the conceptual assistance layer.

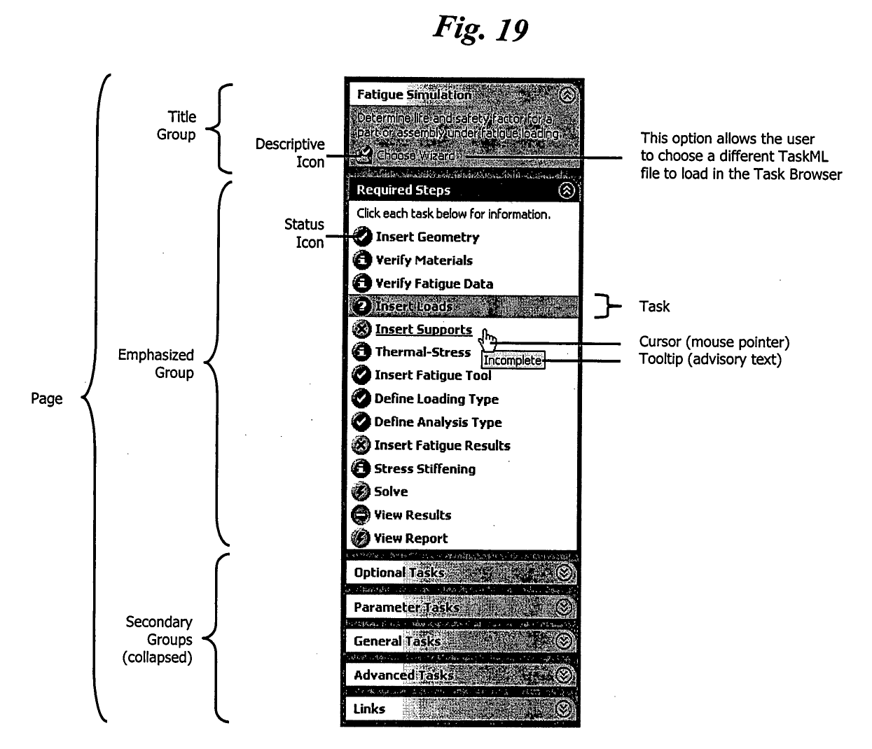

FIG. 19 is a close-up illustrating typical task browser content.

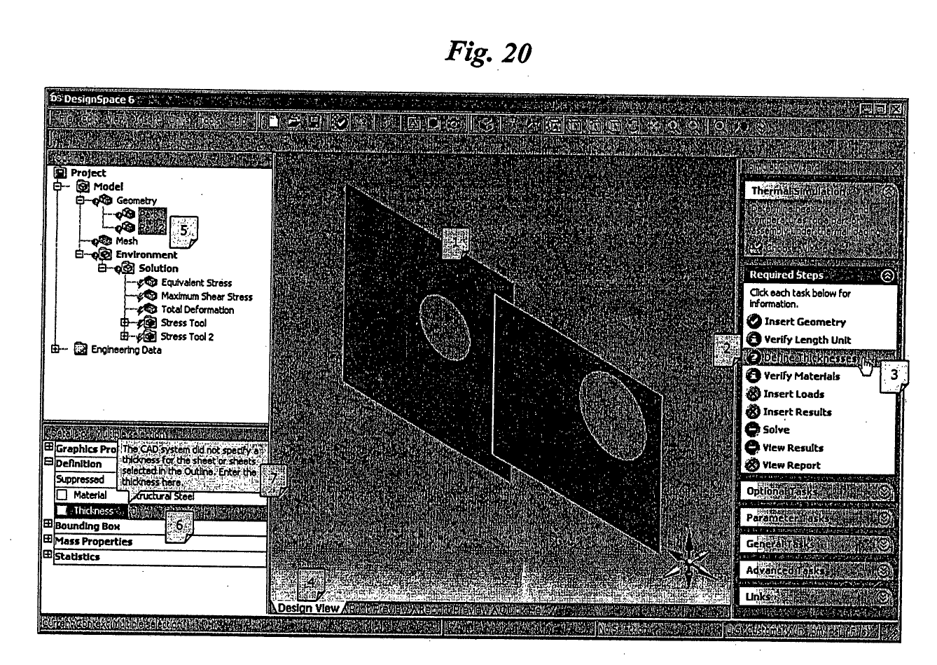

FIG. 20 illustrates sample usage and operation of the task browser:

(1) The geometry inserted into the engineering system did not explicitly define its thickness.

(2) The “Define Thicknesses” task indicates via its status icon that the task requires attention.

(3) The user clicks the “Define Thicknesses” task.

(4) The task ensures that the engineering system is in appropriate mode for completing the task. In this case the task ensures that the Design View tab is active.

(5) The task selects high-level data (objects) needed to complete the task. In this case the task selected all parts with no thickness defined.

(6) The task selects low-level data (properties) needed to complete the task. In this case the task selected the Thickness field in the Details control.

(7) The task displays a Callout providing in-context information to assist the user in completing the task.

FIG. 21 is an example of dynamically generated (not predefined) tasks based on functional rules and integrated script code.

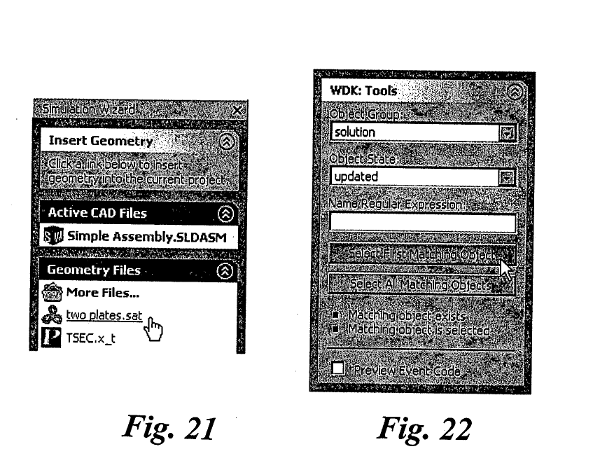

FIG. 22 is an example of UI customization by integrating an HTML page (IFRAME) into a task browser group.

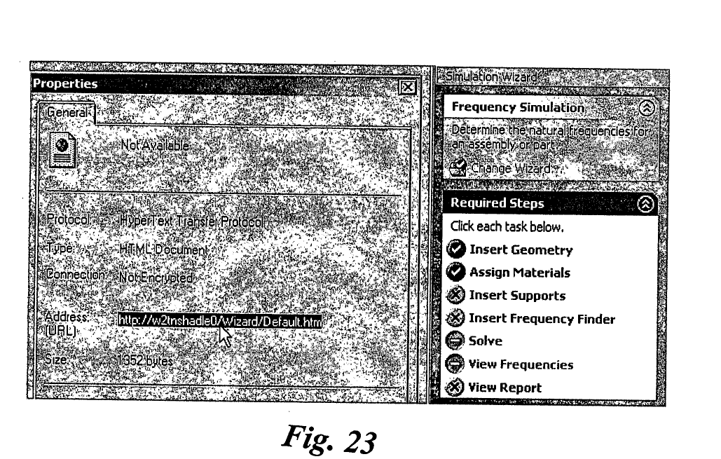

FIG. 23 is an example of the task browser running inside an engineering system via HTTP from a web server.

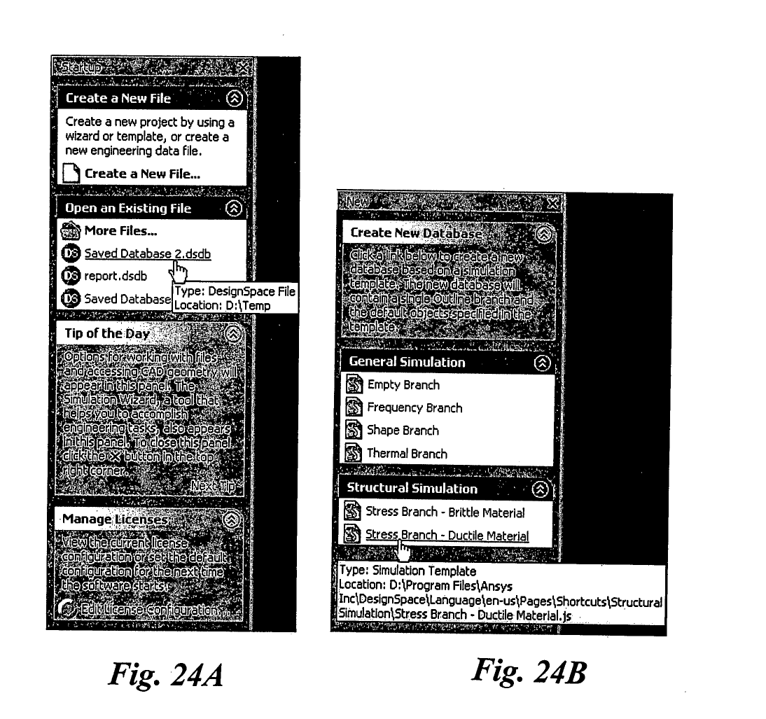

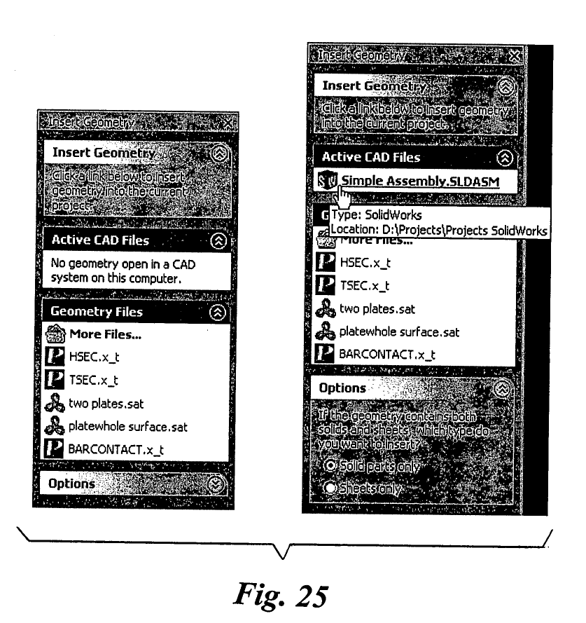

FIGS. 24A and 24B illustrate exemplary Startup and New Database panels, respectively.

FIG. 25 illustrates an exemplary Insert Geometry panel showing dynamic content and UI extension.

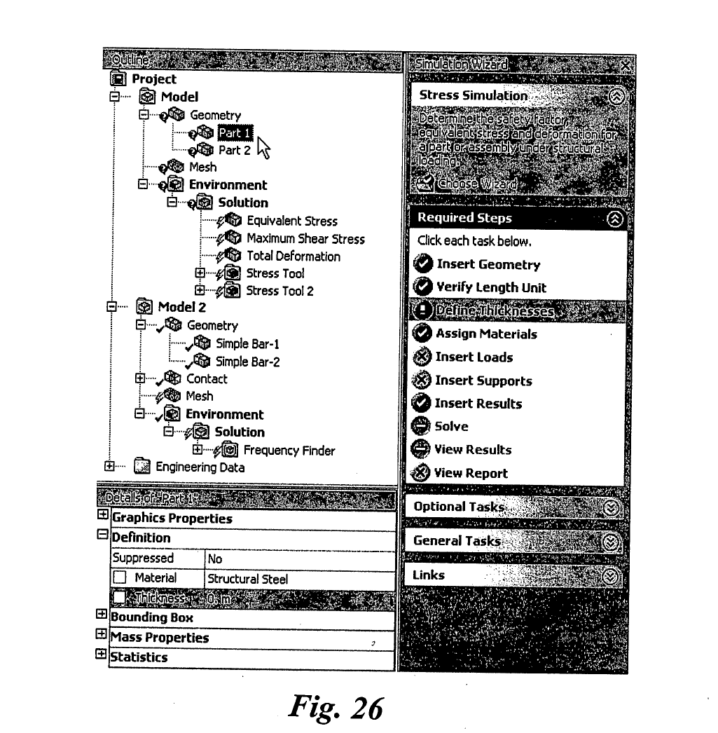

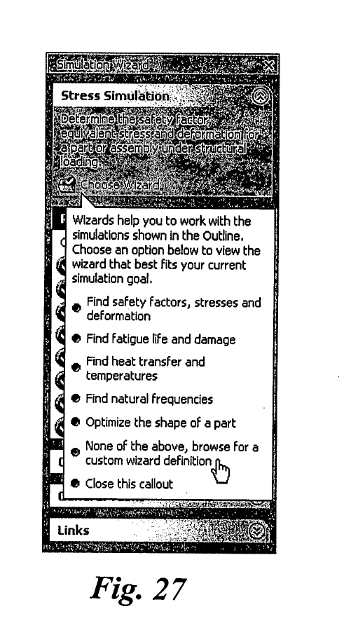

FIG. 26 illustrates two outline branches with different geometry and different simulation goals. The task browser adapts to the current selection in the outline.

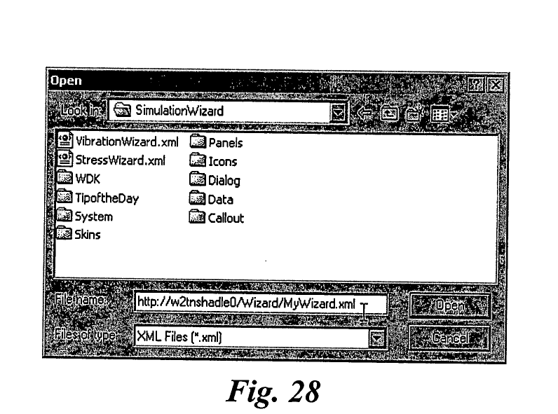

FIG. 27 illustrates a “choose callout” which allows the user to switch task browsers at any time without affecting their work.

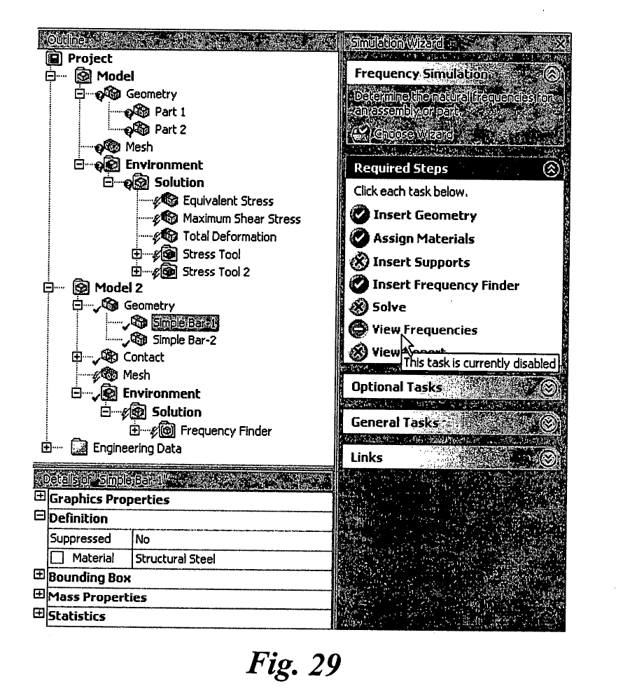

FIG. 28 illustrates a browse option which allows the user to choose a custom task browser definition from a local or network location.

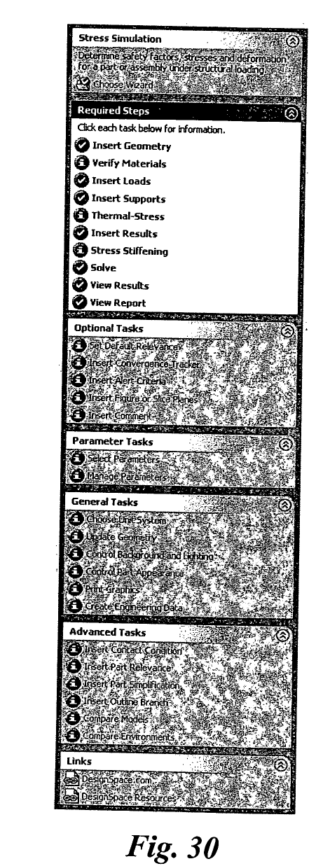

FIG. 29 illustrates working in a second branch with a different task browser configuration. The task browser automatically removed the geometry-specific tasks (length, unit and thickness) responding to the type of geometry in the context of the selection.

FIG. 30 illustrates a fully expanded task browser. The optional and general groups extend the scope of a basic task browser and allow all users access to, for example, engineering system capabilities via a flat list of recognizable, high-level tasks. The links group can provide a quick access to project and net resources, template-based e-mail or specific help topics.

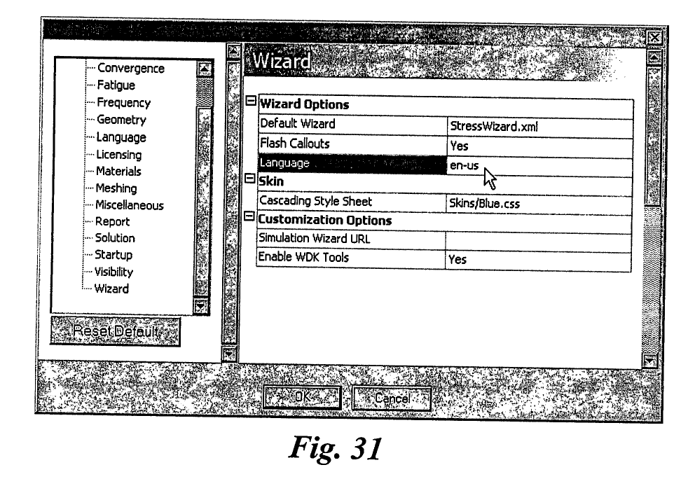

FIG. 31 illustrates “control panel” options (preference) for a task browser. The language may be set independently on the system and changed on the fly (task browsers may be available in more languages than the system or may be modified to use a shop's jargon). The appearance of the task browser is entirely controlled via selection of a “skin” defined by a standard CSS style and images. Customization tools may be provided as an integral feature.

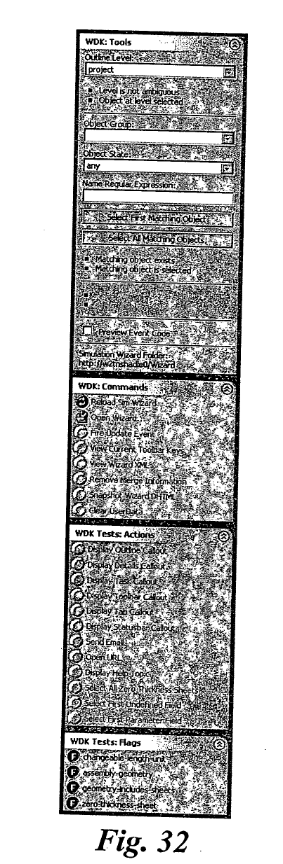

FIG. 32 illustrates enablement of a task browser development kit in a control panel which appends four groups to the task browser. The groups contain tools useful for customizing and testing the task browser.

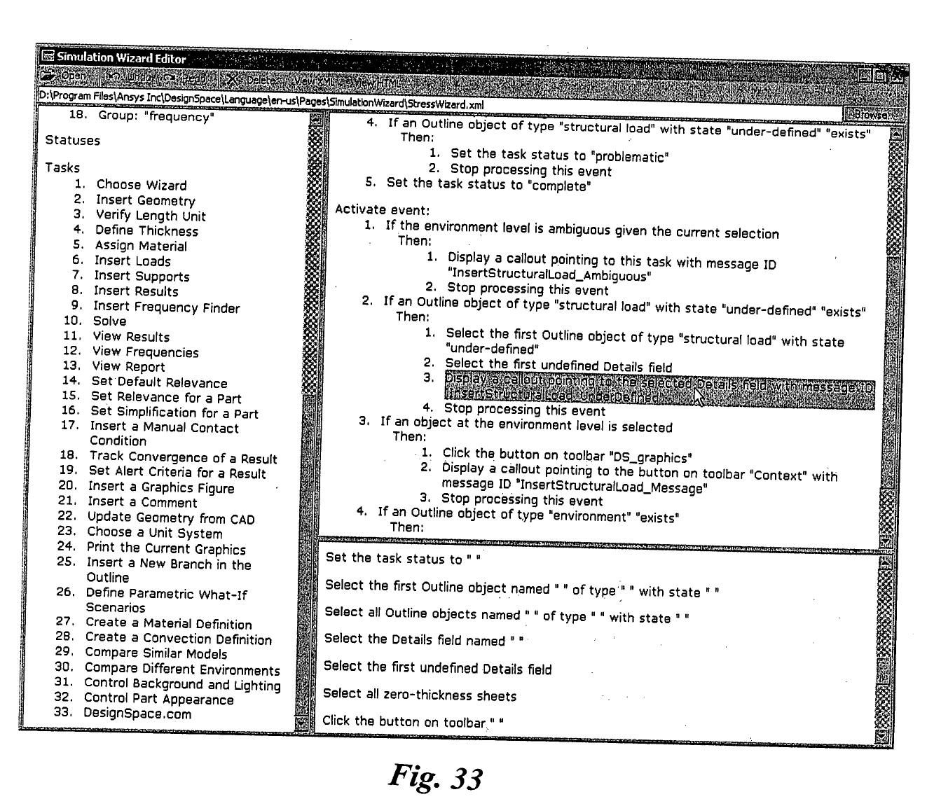

FIG. 33 illustrates an exemplary browser editor. The user edits browser definitions by dragging-and-dropping English sentence fragments into the upper right pane. The exemplary editor may be built as an HTA (HTML application) which requires no installation and can run via HTTP from a web site, opening possibilities for ASP hosting of this application and associated support.

The present invention provides a system for the interpretation and navigation of operations and data in an engineering system via representations of end-user goals and tasks. An apparatus for the representation of the end-user goals and tasks via distributed engineering rule sets may be encoded, for example, in an XML vocabulary. While the present invention has been described in a preferred web-enabled embodiment, it must be understood that the disclosed embodiment is merely exemplary. A substantial number of changes may be made which nevertheless fall within the spirit and scope of the present invention. For example, the invention may be enabled with other types of web tools. Furthermore, the invention may be enabled in a non-web-based system. It is further understood that the preferred embodiment of the present invention is to be embodied in software. The present invention covers not only the software and methods implemented by the software, but also media and other storage devices carrying the software, as well as discreet components and systems executing the software or performing the methods disclosed herein.

What is claimed is:

1. A computer implemented method of interacting with engineering data, comprising:
identifying incomplete tasks in engineering data generated by an engineering program; and
providing information to a user about each identified incomplete task.

2. The method of claim 1 additionally comprising updating the status of any task that has changed as a result of an event in the engineering program.

3. The method of claim 2 wherein said identifying includes checking the status of the tasks each time an event occurs in the engineering program.

4. The method of claim 1 wherein said providing information includes providing information about an end-user goal in a callout window.

5. The method of claim 1 additionally comprising configuring the engineering program to receive data in response to user input, said user input responsive to the provided information.

6. The method of claim 1 wherein said providing information includes providing information in an assistance layer on top of the information provided by the engineering program's interface.

7. A web enabled method of interacting with engineering data using a task browser comprised of code containing information about tasks in an engineering program, said task browser being loaded into a browser, said method comprising:
identifying incomplete tasks in engineering data generated by an engineering program running in a first location; and
providing information about said incomplete tasks to a user at a second location.

8. The method of claim 7 additionally comprising updating the status of any task that has changed as a result of an event in the engineering program.

9. The method of claim 8 wherein said identifying includes checking the status of the tasks each time an event occurs in the engineering program.

10. The method of claim 7 wherein said providing information includes generating a call-out window containing information about an end-user goal related to an incomplete task.

11. The method of claim 7 additionally comprising configuring the engineering program to receive data in response to user input, said user input responsive to the provided information.

12. The method of claim 7 wherein said providing information includes providing information in an assistance layer on top of information provided by the engineering program's interface.

13. A task browser implemented in software which, when executed, performs the following:
identifying incomplete tasks in engineering data generated by an engineering program; and
controlling the provision of information about an incomplete task to a user.

14. The task browser of claim 13 additionally comprising updating the status of any task that has changed as a result of an event in the engineering program.

15. The task browser of claim 14 wherein said identifying includes checking the status of the tasks each time an event occurs in the engineering program.

16. The task browser of claim 13 wherein said controlling the provision of information includes controlling the provision of information about an end-user goal in a call-out window.

17. The task browser of claim 13 wherein said controlling the provision of information includes providing information in an assistance layer on top of information provided by the engineering program's interface.

18. The task browser of claim 13 wherein said software includes a library of tasks constructed using XML.

19. The task browser of claim 13 additionally comprising a natural language editor for editing said library of tasks.

20. A task browser, comprising:
software for interpreting data in an engineering system and, responsive to said interpretation, for navigating a user through operations in the engineering system by enabling the display of one of end-user goals and tasks.

21. The task browser of claim 20 wherein said software comprises:
a task browser object comprising:
a global strings object;
a call-out manager object;
a document object model containing a file of task information; and
an application object for managing connections to the engineering system.

22. The task browser of claim 20 wherein said file of task information is implemented in XML.

23. The task browser of claim 20 wherein said software includes information about end-user goals and tasks encoded as rule sets in a web vocabulary.

24. The task browser of claim 23 additionally comprising a natural language editor for editing said rule sets.

25. The task browser of claim 20 wherein said display of one of end-user goals and tasks is provided in an assistance layer.

26. A computer implemented system, comprising:
an engineering program containing a call-out component and hosting a browser component;
a browser document object model exposed by the browser component, said browser document object model comprising a task browser and a global script to which said call-out component has access, said browser document object model interpreting data in said engineering program and cooperating with said call-out component and said global script to navigate a user through operations in the engineering program.

27. The system of claim 26 wherein said task browser comprises:
a global strings object;
a call-out manager object;
a document object model containing a file of task information; and
an application object.

28. The system of claim 26 wherein said browser document object model is implemented in XML.

29. The system of claim 26 wherein various instances of the browser document object model can be instantiated using remote resources.

30. The system of claim 26 additionally comprising a natural language editor for editing said browser document object model.

31. The system of claim 26 wherein said navigation of a user includes providing information in an assistance layer.

32. A computer implemented system, comprising:
an engineering program hosting a browser component; and
a browser document object model exposed by said browser component, said browser document object model comprised of the merger of task files, object groups and statuses.

33. The system of claim 32 wherein said task files, object groups and statuses are at different locations.

34. The system of claim 32 wherein said browser document object model is implemented in XML.

35. The system of claim 32 additionally comprising a natural language editor for editing said browser document object model.
